(19) United States
(12) Patent Application Publication
(10) Pub. No.: US 2021/0320337 A1
(43) Pub. Date: Oct. 14, 2021

(54) BATTERY MODULE

(71) Applicant: CONTEMPORARY AMPEREX TECHNOLOGY CO., LIMITED, Ningde (CN)

(72) Inventors: Xingdi CHEN, Ningde (CN); Kaijie YOU, Ningde (CN); Ziyuan LI, Ningde (CN); Yanhuo XIANG, Ningde (CN); Dongyang SHI, Ningde (CN); Fei HU, Ningde (CN)

(73) Assignee: CONTEMPORARY AMPEREX TECHNOLOGY CO., LIMITED, Ningde (CN)

(21) Appl. No.: 17/357,057

(22) Filed: Jun. 24, 2021

Related U.S. Application Data
(63) Continuation of application No. PCT/CN2019/079233, filed on Mar. 22, 2019.

(30) Foreign Application Priority Data
Dec. 28, 2018 (CN) 201822239520.4

(51) Int. Cl. H01M 10/42; A62C 3/16; H01M 50/24

(52) U.S. Cl. CPC H01M 10/425; H01M 50/24; A62C 3/16

(57) ABSTRACT

The application provides a battery module, which includes a plurality of batteries, an upper cover, and a pressing strip. The pressing strip covers an explosion-proof valve of a battery, and includes a main body portion and a bottom plate portion. The bottom plate portion is connected to the main body portion and forms an accommodating cavity together with the main body portion. A fire extinguishing agent is sealed in the accommodating cavity. The bottom plate portion of the pressing strip is configured to be melted. The fire extinguishing agent is constantly stored in the accommodating cavity of the pressing strip, so as to avoid wasteful use of the fire extinguishing agent caused by the same flowing in all directions, so that the amount of the fire extinguishing agent can be maintained at a constant level at all times.

### CROSS-REFERENCE TO RELATED APPLICATIONS

This application is a continuation of International Application No. PCT/CN2019/079233, filed on Mar. 22, 2019, which claims priority to Chinese Patent Application No. 201822239520.4, filed on Dec. 28, 2018, both of which are hereby incorporated by reference in their entireties.

### TECHNICAL FIELD

The application relates to the technical field of batteries, in particular, to a battery module.

### BACKGROUND

During the using process of a battery module, there is usually a risk of a thermal runaway. Currently, in order to reduce the risk of the thermal runaway and reduce an impact brought by the thermal runaway, methods commonly used at present are as follows: (1) a complicated fire extinguishing liquid pipeline is arranged in a box body of the battery module, which is difficult to design and assemble and costly, and it takes up a lot of space in the box, thus resulting in a low energy density of the battery module; (2) fire extinguishing fluid is directly disposed in the box body, during the using process of the battery module, the fire extinguishing fluid can easily flow in all directions and adhere to other positions, so that the effective extinguishing fluid in the box body become less and less, and at the moment of the thermal runaway, the fire extinguishing fluid may be just outside a flame position of the battery, thus resulting in an inability to extinguish the fire timely; (3) fire resistant materials are arranged at the flame position of the battery to withstand the fire, but it can easily make the thermal runaway diffuse in the battery module, resulting in more and more battery thermal runaways, thereby increasing the degree of the thermal runaway.

### SUMMARY

In view of the problems in the background art, an objective of the application is to provide a battery module, which its fire extinguishing agent is stored in a constant location close to an explosion-proof valve of a battery, so that preventing the fire extinguishing agent from flowing in all directions and enabling the fire extinguishing agent to timely flow into the interior of the battery when the explosion-proof valve is rupturing, thereby reducing the degree of a thermal runaway.

In order to realize the above objective, the application provides the battery module, which includes a plurality of batteries, an upper cover, and a pressing strip. The plurality of batteries are arranged in a longitudinal direction, each battery is provided with the explosion-proof valve. The upper cover is disposed above the plurality of batteries in an up and down direction. The pressing strip is disposed between the plurality of batteries and the upper cover, and covers the explosion-proof valve of the battery, and the pressing strip includes: a main body portion; and a bottom plate portion, connected to the main body portion and forms an accommodating cavity together with the main body portion, and the fire extinguishing agent is sealed in the accommodating cavity. Among them, the bottom plate portion of the pressing strip is configured to discharge the fire extinguishing agent from the accommodating cavity after being melted.

Thicknesses of the bottom plate portion is smaller than thicknesses of the main body portion.

The bottom plate portion of the pressing strip is a thin wall structure with uniform thicknesses.

The bottom plate portion includes: a body; and a plurality of weakened areas, disposed on the body at intervals in the longitudinal direction. Each weakened area corresponds to the explosion-proof valve of one battery and is configured to discharge the fire extinguishing agent from the accommodating cavity after being melted.

The pressing strip further includes: an opening for injecting the fire extinguishing agent into the accommodating cavity. The battery module further includes: a sealing cover for sealing the opening of the pressing strip after injecting the fire extinguishing agent into the accommodating cavity. The openings of the pressing strip are the same in quantity as the accommodating cavity.

The accommodating cavity is one in quantity, and the accommodating cavity extends in the longitudinal direction and covers the explosion-proof valves of all the batteries.

The accommodating cavities are multiple in quantity, and each opening of the pressing strip passes through an upper wall of the main body portion in the up and down direction and is connected to the corresponding accommodating cavity.

The accommodating cavities are multiple in quantity, the multiple accommodating cavities include a first accommodating cavity and a second accommodating cavity. The pressing strip further includes: a partition wall, extending in the up and down direction and connected to the bottom plate portion and the main body portion. The first accommodating cavity and the second accommodating cavity are located on both sides of the partition wall in the longitudinal direction, respectively, and the first accommodating cavity and the second accommodating cavity cover the explosion-proof valve of the corresponding battery, respectively.

The partition wall is one or multiple in quantity.

The partition wall together with the main body portion and bottom plate portion enclose the first accommodating cavity and the second accommodating cavity.

The pressing strip is fixed on a top cover plate of the plurality of batteries.

The pressing strip is glued on the top cover plate of the plurality of batteries.

The battery module further includes: two end plates, disposed at both ends of the plurality of batteries in the longitudinal direction, respectively, and the pressing strip is fixed on the two end plates.

The two end plates are configured to fix the plurality of batteries.

The upper cover is used to protect the plurality of batteries, so as to avoid a problem of short circuit caused by external conductive materials contacting with the top cover plate and/or the electrode terminal of the battery.

A melting point of the pressing strip is lower than the internal temperature of the battery when the battery occurs a thermal runaway.

A melting point of the pressing strip is 200° C. to 500° C.

A material of the pressing strip is metal.

The material of the pressing strip is aluminum.

The advantageous effects of the application are as follows:

the fire extinguishing agent is constantly stored in the accommodating cavity of the pressing strip, so as to avoid wasteful use of the fire extinguishing agent caused by the same flowing in all directions, so that the amount of the fire extinguishing agent can be maintained at a constant level at all times. When the battery occurs the thermal runaway, a high-temperature substance in the battery can break through the explosion-proof valve. And at this time, the high-temperature substance can melt the bottom plate portion of the pressing strip and the fire extinguishing agent can be timely discharged from the accommodating cavity, thereby enabling the fire extinguishing agent to quickly flow into the interior of the battery to reduce the temperature therefore, preventing the diffusion of the thermal runaway, and greatly reducing the degree of the thermal runaway, so as to fight for time for passengers to escape and/or manually extinguish the thermal runaway.

Another aspect of the present disclosure provides an apparatus including the battery module according to any of the above embodiments, wherein the battery module is adapted to provide power for the apparatus.

### BRIEF DESCRIPTION OF DRAWINGS

FIG. 1 is an exploded view of a battery module of the application.

FIG. 2 is a cross-sectional schematic view of assembled parts in FIG. 1, in which an upper cover is omitted.

FIG. 3 is an enlarged view of a circle portion in FIG. 2.

FIG. 4 is a perspective view of a pressing strip in FIG. 1 as seen from the back.

FIG. 5 is a modified example of FIG. 4.

FIG. 6 is the other modified example of FIG. 4 and shows a sealing cover corresponding to each opening.

FIG. 7 is a cross-sectional schematic view of the interior of the pressing strip in FIG. 6.

Reference signs are explained as follows:

| | |
|---|---|
| 1 battery | 33A first accommodating cavity |
| 11 explosion-proof valve | 33B second accommodating cavity |
| 12 top cover plate | 34 opening |
| 2 upper cover | 35 partition wall |
| 3 pressing strip | 4 fire extinguishing agent |
| 31 main body portion | 5 sealing cover |
| 32 bottom plate portion | 6 end plate |
| 321 body | X transverse direction |
| 322 weakened area | Y longitudinal direction |
| 33 accommodating cavity | Z up and down direction |

### DESCRIPTION OF EMBODIMENTS

To make the objectives, technical solutions, and advantages of the present application clearer and more comprehensible, the present application can be further described below in detail with reference to the accompanying drawings and embodiments. It should be understood that the specific embodiments described herein are merely used to explain the present application, but are not intended to limit the present application.

In the description of the present application, unless otherwise specified and limited explicitly, the terms “first” and “second” are merely intended for a purpose of description, and shall not be understood as an indication or implication of relative importance. The term “a plurality of” refers to two or more than two. Unless otherwise specified or illustrated, the term “connection” should be understood broadly, for example, the “connection” can either be a fixed connection, or a detachable connection, or an integrated connection, or an electrical connection, or a signal connection; and the “connection” can either be a direct connection, or an indirect connection through an intermediary. Those of ordinary skill in the art can appreciate the specific meanings of the foregoing terms in the present application according to specific conditions.

In the description of the specification, it should be understood that the terms representing directions such as “up” and “down” described in the embodiments of the present application are described from the angles shown in the accompanying drawings, and should not be understood as limitation on the embodiments of the present application. In addition, in the context, it should also be understood that when it is mentioned that an element is connected “up” or “down” to the other element, it can not only be directly connected “up” or “down” to the other element, but also be indirectly connected “up” or “down” to the other element through an intermediate element. The present application can be further described below in detail through the specific embodiments with reference to the accompanying drawings.

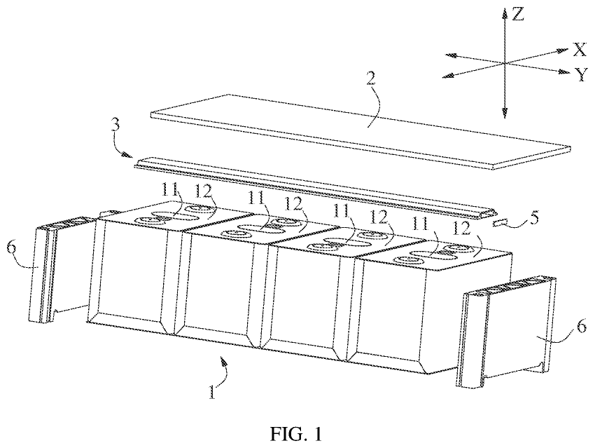

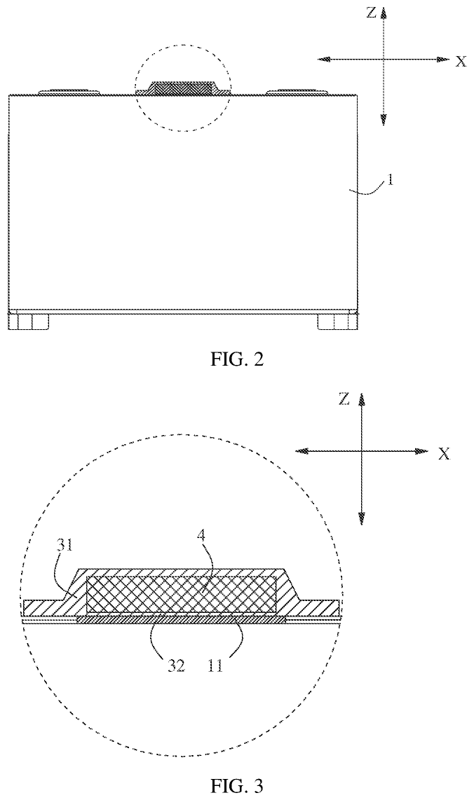

Referring to FIGS. 1 and 2, a battery module of the present application includes a plurality of batteries 1, an upper cover 2, a pressing strip 3, a fire extinguishing agent 4, a sealing cover 5, and two end plates 6.

The plurality of batteries 1 are arranged in a longitudinal direction Y, and each battery 1 includes a top cover plate 12, an electrode terminal 13 disposed on the top cover plate 12 and an explosion-proof valve 11.

An upper cover 2 is disposed above the plurality of batteries 1 in an up and down direction Z, which is used to protect the plurality of batteries 1, so as to avoid a problem of short circuit caused by external conductive materials contacting with the top cover plate 12 and/or the electrode terminal 13 of the battery 1.

The pressing strip 3 is disposed between the plurality of batteries 1 and the upper cover 2, and covers the explosion-proof valves 11 of the batteries 1. Referring to FIGS. 3 and 7, the pressing strip 3 includes: a main body portion 31 and a bottom plate portion 32 which connected to the main body portion 31 and forms an accommodating cavity 33 together with the main body portion 31, and the fire extinguishing agent 4 is sealed in the accommodating cavity 33. Among them, the bottom plate portion 32 of the pressing strip 3 is configured to discharge the fire extinguishing agent 4 from the accommodating cavity 33 after being melted.

In the battery module of the present application, the fire extinguishing agent 4 is constantly stored in the accommodating cavity 33 of the pressing strip 3, so as to avoid wasteful use of the fire extinguishing agent 4 caused by the same flowing in all directions, so that the amount of the fire extinguishing agent 4 can be maintained at a constant level at all times. When the battery 1 occurs a thermal runaway, a high-temperature substance in the battery 1 (including a high-temperature and high-pressure gas, an electrolyte and other substances) can break through the explosion-proof valve 11. And at this time, the high-temperature substance can melt the bottom plate portion 32 of the pressing strip 3 and the fire extinguishing agent 4 can be timely discharged from the accommodating cavity 33, thereby enabling the fire extinguishing agent 4 to quickly flow into the interior of the battery 1 to reduce the temperature therefore, preventing the diffusion of the thermal runaway, and greatly reducing the degree of the thermal runaway, so as to fight for time for passengers to escape and/or manually extinguish the thermal runaway.

In order to ensure the bottom plate portion 32 of the pressing strip 3 can be smoothly melted by the high-temperature substance flushed out from the interior of the battery 1, a melting point of the pressing strip 3 is lower than the internal temperature of the battery 1 when the battery 1 occurs the thermal runaway, in some embodiments, the melting point of the pressing strip 3 is 200° C. to 500° C.

A material of the pressing strip can be metal. In some embodiments, the material of the pressing strip 3 is aluminum. The fire extinguishing agent 4 can be water, dry powder, carbon dioxide and other common fire extinguishing materials.

When the battery 1 occurs the thermal runaway, in order to prevent the high-temperature substance flushed out from the battery 1 from continuing to melt the main body portion 31 after melting the bottom plate portion 32 of the pressing strip 3, thus resulting in the waste of the fire extinguishing agent 4, thicknesses of the main body portion 31 is greater than thicknesses of the bottom plate portion 32.

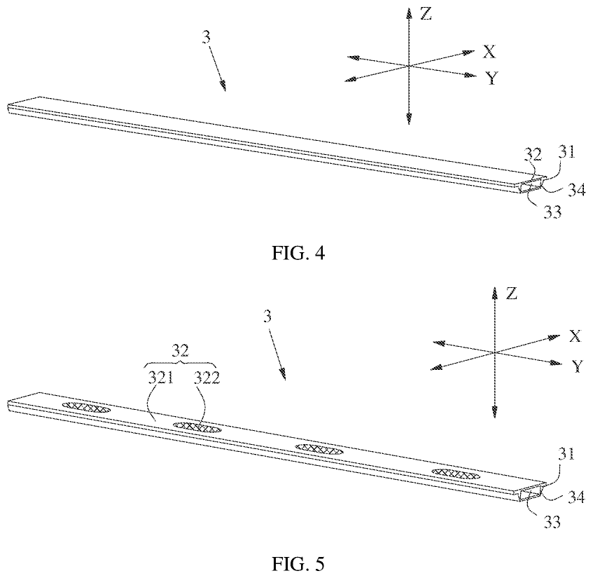

In one embodiment, referring to FIGS. 3 and 4, the bottom plate portion 32 of the pressing strip 3 can be a thin wall structure with uniform thicknesses.

In the other embodiment, referring to FIGS. 1 and 2, the bottom plate portion 32 of the pressing strip 3 can include: a body 321 and a plurality of weakened areas 322 which disposed on the body 321 at intervals in the longitudinal direction Y. Each weakened area 322 corresponds to an explosion-proof valve 11 of a battery 1 and is configured to discharge the fire extinguishing agent 4 from the accommodating cavity 33 after being melted. When one or several batteries 1 occur the thermal runaway, only the weakened area 322 corresponding to each battery 1 is melted by the high-temperature substance flushed out from the interior of the corresponding battery 1. At this time, the fire extinguishing agent 4 in the accommodating cavity 33 is prevented from flowing to other places except the interior of each battery 1 (such as above the top cover plate 12 of the battery 1), so that the fire extinguishing agent 4 can be fully utilized, thus quickly reducing the temperature of the corresponding battery 1.

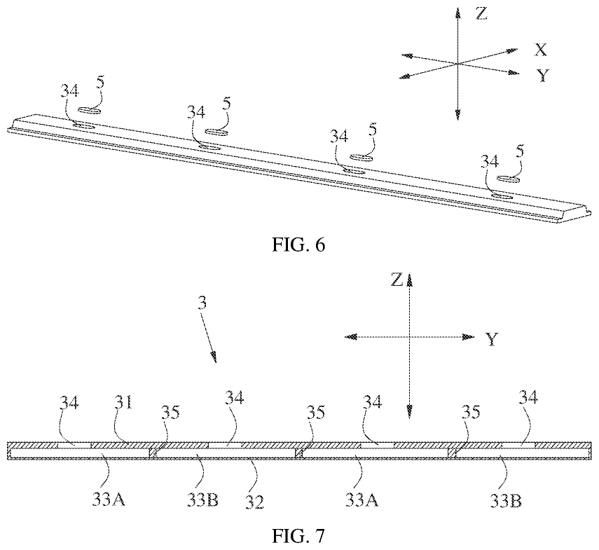

Referring to FIGS. 1 and 6, the pressing strip 3 further includes: an opening 34 for injecting the fire extinguishing agent 4 into the accommodating cavity 33. The sealing cover 5 seals the opening 34 of the pressing strip 3 after injecting the fire extinguishing agent 4 into the accommodating cavity 33. Among them, the opening 34 of the pressing strip 3 is the same in quantity as the accommodating cavity 33.

In one embodiment, referring to FIGS. 4 and 5, the accommodating cavity 33 is one in quantity, and the accommodating cavity 33 extends in the longitudinal direction Y and covers the explosion-proof valves 11 of all the batteries 1.

In the other embodiment, referring to FIGS. 6 and 7, the accommodating cavities 33 are multiple in quantity, and each opening 34 of the pressing strip 3 passes through an upper wall of the main body portion 31 in the up and down direction Z and is connected to the corresponding accommodating cavity 33.

The multiple accommodating cavities 33 include a first accommodating cavity 33A and a second accommodating cavity 33B. The pressing strip 3 further includes: a partition wall 35, extending in the up and down direction Z and connected to the bottom plate portion 32 and the main body portion 31. The partition wall 35, together with the main body portion 31 and bottom plate portion 32, enclose the first accommodating cavity 33A and the second accommodating cavity 33B. Among them, the partition wall 35 can be one or multiple in quantity.

The first accommodating cavity 33A and the second accommodating cavity 33B are located on both sides of the partition wall 35 in the longitudinal direction Y respectively, and the first accommodating cavity 33A and the second accommodating cavity 33B cover the explosion-proof valves 11 of the corresponding batteries 1 respectively.

The two end plates 6 are disposed at both ends of the plurality of batteries 1 in the longitudinal direction Y respectively to clamp and fix the plurality of batteries 1. Among them, the pressing strip 3 can be fixed (for example, glued) on the top cover plate 12 of the plurality of batteries 1, and can also be fixed on the two end plates 6.

The embodiments of the present disclosure further provide an apparatus, which includes a battery module according to any of the embodiments as described above, wherein the battery module is adapted to provide power for the apparatus. The apparatus may be an electric vehicle, a hybrid vehicle, an electric scooter, an electric cart or any other suitable devices which can include the battery module as their own power source.

What is claimed is:

1. A battery module, comprising:
a plurality of batteries, arranged in a longitudinal direction, each battery is provided with an explosion-proof valve;
an upper cover, disposed above the plurality of batteries in an up and down direction; and
a pressing strip, disposed between the plurality of batteries and the upper cover and covers the explosion-proof valves of the batteries, wherein the pressing strip comprises: a main body portion and a bottom plate portion which connected to the main body portion and forms an accommodating cavity together with the main body portion, and a fire extinguishing agent is sealed in the accommodating cavity;
wherein the bottom plate portion of the pressing strip is configured to discharge the fire extinguishing agent from the accommodating cavity after being melted.

2. The battery module according to claim 1, wherein thicknesses of the bottom plate portion is smaller than thicknesses of the main body portion.

3. The battery module according to claim 1, wherein the bottom plate portion of the pressing strip is a thin wall structure with uniform thicknesses.

4. The battery module according to claim 1, wherein the bottom plate portion comprises: a body and a plurality of weakened areas which disposed on the body at intervals in the longitudinal direction;
each weakened area corresponds to an explosion-proof valve of a battery and is configured to discharge the fire extinguishing agent from the accommodating cavity after being melted.

5. The battery module according to claim 1, wherein the pressing strip further comprises: an opening for injecting the fire extinguishing agent into the accommodating cavity;
the battery module further comprises: a sealing cover for sealing the opening of the pressing strip after injecting the fire extinguishing agent into the accommodating cavity;
the opening of the pressing strip is the same in quantity as the accommodating cavity.

6. The battery module according to claim 5, wherein the accommodating cavity is one in quantity, and the accommodating cavity extends in the longitudinal direction and covers the explosion-proof valves of all the batteries.

7. The battery module according to claim 5, wherein the accommodating cavities are multiple in quantity, and each opening of the pressing strip passes through an upper wall of the main body portion in the up and down direction and is connected to the corresponding accommodating cavity.

8. The battery module according to claim 5, wherein the accommodating cavities are multiple in quantity, and the multiple accommodating cavities comprise a first accommodating cavity and a second accommodating cavity;
the pressing strip further comprises: a partition wall, extending in the up and down direction and connected to the bottom plate portion and the main body portion;
the first accommodating cavity and the second accommodating cavity are located on both sides of the partition wall in the longitudinal direction respectively, and the first accommodating cavity and the second accommodating cavity cover the explosion-proof valves of the corresponding batteries respectively.

9. The battery module according to claim 8, wherein the partition wall is one or multiple in quantity.

10. The battery module according to claim 8, wherein the partition wall together with the main body portion and bottom plate portion enclose the first accommodating cavity and the second accommodating cavity.

11. The battery module according to claim 1, wherein the pressing strip is fixed on a top cover plate of the plurality of batteries.

12. The battery module according to claim 11, wherein the pressing strip is glued on the top cover plate of the plurality of batteries.

13. The battery module according to claim 1, wherein the battery module further comprises: two end plates, disposed at both ends of the plurality of batteries in the longitudinal direction respectively, and the pressing strip is fixed on the two end plates.

14. The battery module according to claim 13, wherein the two end plates are configured to fix the plurality of batteries.

15. The battery module according to claim 1, wherein the upper cover is used to protect the plurality of batteries, so as to avoid a problem of short circuit caused by external conductive materials contacting with the top cover plate and/or the electrode terminal of the battery.

16. The battery module according to claim 1, wherein a melting point of the pressing strip is lower than the internal temperature of the battery when the battery occurs a thermal runaway.

17. The battery module according to claim 1, wherein a melting point of the pressing strip is 200° C. to 500° C.

18. The battery module according to claim 17, wherein the pressing strip is a metal pressing strip.

19. The battery module according to claim 18, wherein the material of the pressing strip is aluminum.

20. An apparatus, comprising the battery module according to claim 1, wherein the battery module is adapted to provide power for the apparatus.
